(19) United States
(12) Patent Application Publication
(10) Pub. No.: US 2025/0085680 A1
(43) Pub. Date: Mar. 13, 2025

(54) SENSOR NETWORK SYSTEM

(71) Applicant: FRABA BV., SG HEERLEN (NL)

(72) Inventors: TOBIAS SCHUBERT, KOELN (DE); DIMITRI PRITZKAU, TROISDORF (DE)

(73) Assignee: FRABA B.V., SG HEERLEN (NL)

(21) Appl. No.: 18/689,076

(22) PCT Filed: Sep. 6, 2021
(86) PCT No.: PCT/EP2021/074455

§ 371 Date: Dec. 4, 2024

(51) Int. Cl. G05B 19/042; H04L 67/12

(52) U.S. Cl. CPC G05B 19/042; H04L 67/12; G05B 2219/21018; G05B 2219/32179; G05B 2219/45012

(57) ABSTRACT

A Sensor network system (10) with a plurality of sensor devices (12_1 12_5), each comprising:
a detection unit (16, 18) for detecting a physical quantity and for providing a corresponding measurement signal,
a computing unit (20) for processing the measurement signal and for providing measurement data (M_1-M_5) which is based on the measurement signal, and
a data interface (22) via which output data (A_1-A_5) can be read out, is known.

In order to provide an efficient sensor network system (10), according to the present invention, a central evaluation unit (24) is provided, which is configured to:
determine individual output data (A_1-A_5) for the at least two sensor devices (12_1-12_5) based on the measurement data (M_1-M_5) of at least two of the sensor devices (12) via a central evaluation algorithm, and
provide the determined output data (A_1-A_5) to the respective sensor device (12_1-12_5).

The present invention is directed to a sensor network system with a plurality of sensor devices, each comprising: a detection unit for detecting a physical quantity and for providing a corresponding measurement signal, a computing unit for processing the measurement signal and for providing measurement data which is based on the measurement signal, and a data interface via which output data can be read out.

Such sensor network systems can be used, for example, for monitoring machines or industrial facilities, wherein the individual sensor devices are typically arranged on different parts of the machine or industrial facility, respectively.

A sensor network system with a plurality of sensor devices is known, for example, from WO 2021/052585 A1, wherein the output data of all sensor devices are transmitted to a base station, via which they can then be read out externally. The output data of the individual sensor devices are determined individually by each sensor device, so that each sensor device must be provided with a correspondingly powerful computing unit.

Against this background, the task is to provide an efficient sensor network system.

This task is solved by a sensor network system with the features of main claim 1.

The sensor network system according to the present invention comprises a plurality of preferably identical sensor devices. However, the sensor network system can in principle also comprise any number of different types of interconnected sensor devices. The sensor devices are interconnected in a known manner via a data transmission network, for example via a data bus, in order to allow a data exchange between the individual sensor devices as well as potentially existing further participants of the sensor network system.

Each sensor device according to the present invention comprises at least one detection unit for detecting a physical quantity and for providing a corresponding measurement signal. Advantageously, the sensor device can comprise several detection units for detecting several different physical variables.

Each sensor device according to the present invention further comprises a computing unit for processing the at least one measurement signal and for providing measurement data which is based on the at least one measurement signal. Typically, the computing unit comprises a microcontroller or a so-called system-on-a-chip (SoC) as well as a data storage.

The measurement signal provided by the sensor unit can be an analog signal from the amplitude and/or frequency of which the respective physical quantity can be derived. In this case, the computing unit comprises a so-called analog-to-digital converter for converting the analog measurement signal into a digital data stream of measurement signal values. The measurement signal can, however, also be a digital signal, i.e. a digital data stream, which comprises at least one measurement value. In principle, the measurement signal can be any signal that can be used to transmit information about the physical quantity detected by the sensor unit.

The measurement data provided by the computing unit typically comprise a measurement value which is derived from the measurement signal or transmitted by the measurement signal and which indicates the physical quantity detected by the sensor unit. However, it is also conceivable that the measurement data comprise a measurement signal frequency value, a measurement signal amplitude value and/or individual measurement signal values of an (analog) measurement signal. In principle, the measurement data provided by the computing unit can be any type of digital data determined based on the measurement signal.

Each sensor device according to the present invention further comprises at least one data interface via which output data, which is determined based on the measurement data, can be read out. Preferably, the sensor device comprises a radio data interface, particularly preferably a mobile radio interface, for data exchange with a remote data processing unit, as well as a wired data interface for data exchange with other participants of the sensor network system.

According to the invention, the sensor network system comprises a central evaluation unit to which the measurement data from at least two of the sensor devices, preferably from all sensor devices, are provided. For this purpose, the respective sensor devices can be configured to actively transmit the measurement data to the central evaluation unit, and/or the central evaluation unit can be configured to retrieve the measurement data from the respective sensor devices. A central evaluation algorithm is stored in the central evaluation unit, typically in the form of an executable computer program, which receives the measurement data from the sensor devices as input and provides individual output data for the individual sensor devices as output. The central evaluation unit is therefore configured to determine—via the central evaluation algorithm—individual output data for the at least two sensor devices based on the measurement data of the at least two sensor devices. Individual output data specific to the respective sensor device is thus determined for each of these sensor devices. According to the present invention, the central evaluation unit is furthermore configured to provide the determined output data to the respective sensor device, so that the output data can then be read out via the data interfaces of the individual sensor devices.

The central evaluation unit is configured to execute a central measurement data evaluation for at least two of the sensor devices of the sensor network system according to the present invention, preferably for all sensor devices of the sensor network system according to the present invention. The central evaluation unit consequently allows the execution of relatively complex evaluation algorithms without the need for providing a correspondingly powerful computing unit in each sensor device. This provides an efficient sensor network system.

Preferably, the central evaluation unit is constituted by the computing unit of one of the sensor devices, so that no separate device needs to be provided in the sensor network system for the central evaluation unit. Typically, the respective computing unit comprises a relatively powerful microcontroller for executing the central evaluation algorithm. In principle, it is also conceivable that the computing units of several sensor devices are configured to constitute the central evaluation unit and that these alternately take over the function of the central evaluation unit. This provides a particularly efficient and versatile sensor network system.

Advantageously, the central evaluation unit is configured to generate at least two sub-calculation commands for calculating an intermediate value of the central evaluation algorithm, to provide the at least two sub-calculation commands to the computing units of at least two different sensor devices, and to receive or retrieve the intermediate values calculated by the at least two sub-calculation commands in the computing units of the at least two different sensor devices from the at least two different sensor devices. The sub-calculation commands can be of any complexity and can also be designed for determining more than one intermediate value of the central evaluation algorithm. Preferably, the central evaluation unit is configured to provide each sub-calculation command to a different computing unit. By dividing the central evaluation algorithm into several sub-calculation commands, which in turn are executed by the computing units of several sensor devices, a relatively complex evaluation algorithm can be executed without having to provide a particularly powerful computing unit for this purpose. This provides a particularly versatile sensor network system.

Preferably, the sensor devices each comprise a gyroscope sensor unit and/or an acceleration sensor unit, the sensor devices are each attached to a different moving part of a machine, and the output data of the sensor devices each indicate a spatial position and/or orientation of the respective part of the machine. The central evaluation unit with the central evaluation algorithm allows a particularly precise determination of the position and/or alignment of the individual machine parts, since the measurement data of all machine parts are available to the central evaluation algorithm. Sensor devices with a gyroscope sensor unit and/or an acceleration sensor unit are also referred to, for example, as angular rate sensors, gyroscope instruments, acceleration meters, acceleration sensors, accelerometers, vibration sensors, oscillation sensors, G sensors, B meters or inertial measuring units. Particularly preferably, the machine is a construction machine, in particular an excavator or a crane, wherein the sensor devices are arranged on different parts of a boom of the construction machine in order to enable detection of the spatial position and orientation of the boom.

An embodiment of a sensor network system according to the present invention is described below with reference to the enclosed figures, wherein

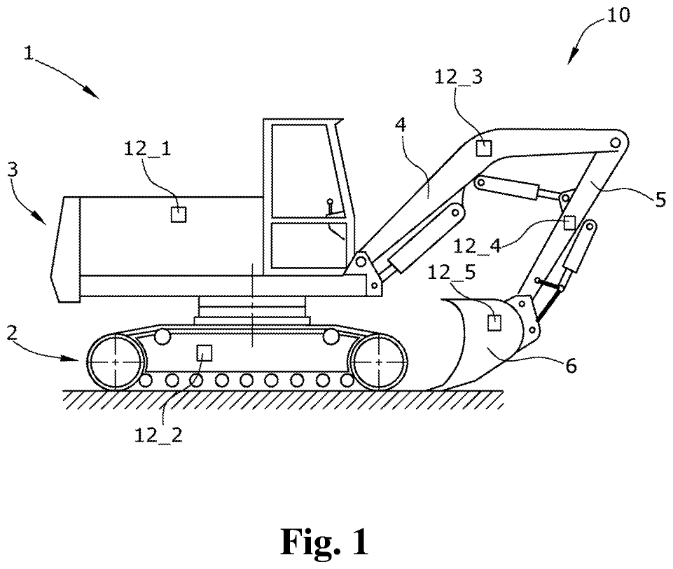

FIG. 1 schematically shows a sensor network system according to the present invention, which is arranged on an excavator,

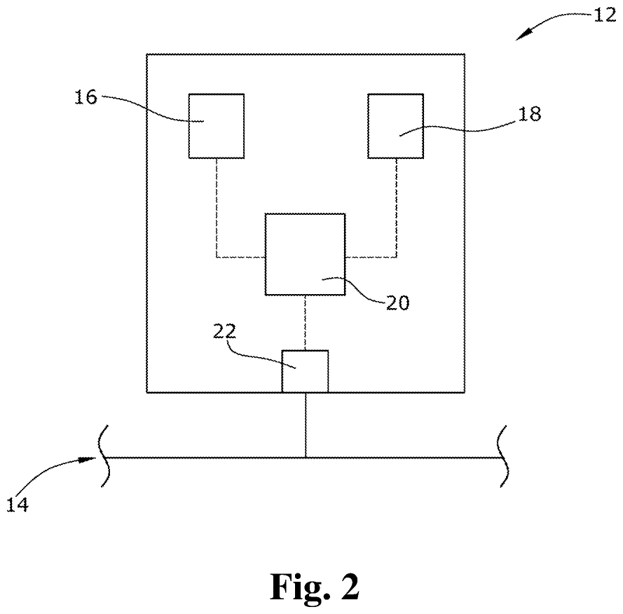

FIG. 2 shows a schematic representation of a sensor device of the sensor network system of FIG. 1, and

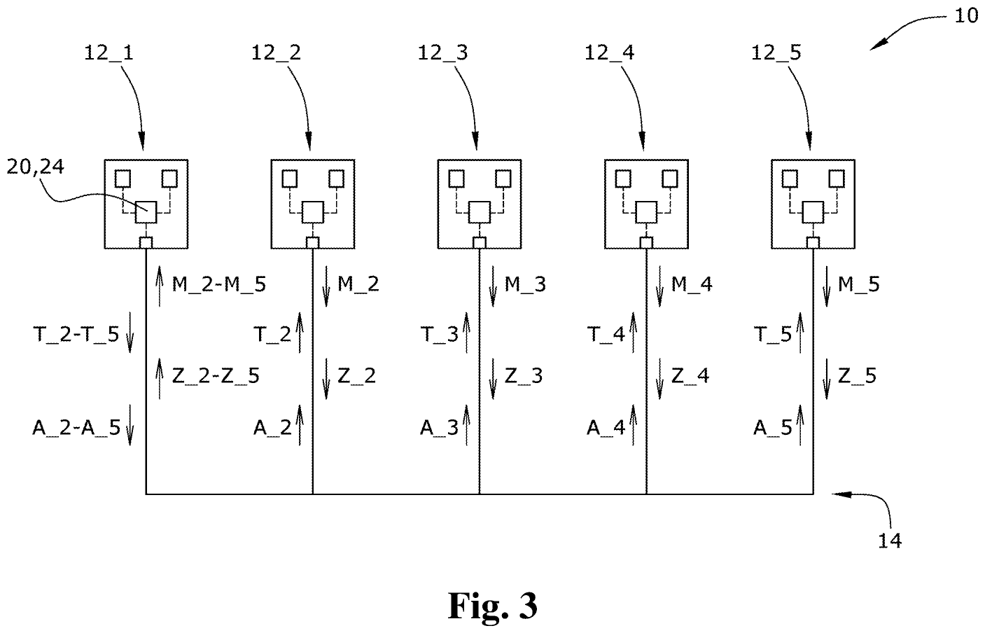

FIG. 3 schematically shows a data exchange between sensor devices of the sensor network system of FIG. 1 during the determination of output data.

FIG. 1 shows an excavator 1 with an undercarriage 2, an upper carriage 3 which is supported on the undercarriage so that it can rotate, a boom 4 which is pivotably attached to the upper carriage 3, a stick 5 which is pivotably attached to the boom 4 and a bucket 6 which is pivotably attached to the stick 5.

FIG. 1 also schematically shows a sensor network system 10 according to the present invention, which is arranged on the excavator 1 in order to detect a spatial position and orientation of the excavator 1 as well as of the individual parts 2-6 of the excavator 1.

The sensor network system 10 comprises five sensor devices 12_1-12_5, which are interconnected via a data transmission network 14. The first sensor device 12_1 is arranged on the upper carriage 3, the second sensor device 12_2 is arranged on the undercarriage 2, the third sensor device 12_3 is arranged on the boom 4, the fourth sensor device 12_4 is arranged on the stick 5, and the fifth sensor device 12_5 is arranged on the bucket 6.

The five sensor devices 12_1-12_5, in the present embodiment, are substantially identically constructed. For simplification, generic reference numerals, i.e. reference numerals without index 1-5, are therefore used in FIG. 2 and in the following description, insofar as they relate to all sensor devices 12_1-12_5 or an arbitrary one of the sensor devices 12_1-12_5.

In the present embodiment, each sensor device 12 comprises two detection units 16, 18. The first detection unit 16 is a three-axis gyroscope sensor unit which is configured to detect rotational velocities along three spatial axes and provide them as a digital rotational velocity measurement signal. The second detection unit 18 is a three-axis acceleration sensor unit which is configured to detect accelerations along three spatial axes and to provide them as a digital acceleration measurement signal.

Each sensor device 12 further comprises a computing unit 20 which is connected to both the detection units 16, 18 and to which the rotational velocity measurement signal and the acceleration measurement signal are provided. The computing unit 20 is configured to process the rotational velocity measurement signal and the acceleration measurement signal and to provide measurement data M which is based thereon. The measurement data M comprise rotational velocity measurement values for the three spatial axes of the gyroscope sensor unit as well as acceleration measurement values for the three spatial axes of the acceleration sensor unit.

Each sensor device 12 further comprises a data interface 22, via which defined output data A can be read out from the sensor device 12. In the present embodiment, the data interface 22 is also used for connection to the data transmission network 14. However, different data interfaces may be provided for connection to the data transmission network 14 of the sensor network system 10 and for reading out the output data A as well.

The sensor network system 10 comprises a central evaluation unit 24, which in the present embodiment is constituted by the computing unit 20 of the first sensor device 12_1. The central evaluation unit 24 is configured to retrieve the measurement data M_2 of the second sensor device 12_2, the measurement data M_3 of the third sensor device 12_3, the measurement data M_4 of the fourth sensor device 12_4 and the measurement data M_5 of the fifth sensor device 12_5 via the data transmission network 14. The central evaluation unit 24 also has access to the measurement data M_1 of the first sensor device 12_1.

The central evaluation unit 24 comprises a central evaluation algorithm which is designed to determine individual output data A_1-A_5 for each of the sensor devices 12_1-12_5 based on the measurement data M_1-M_5 of the sensor devices 12_1-12_5. In the present embodiment, the five determined output data A_1-A_5 each indicate at least an inclination of the respective sensor device 12 and thus of the respective part 2,3,4,5,6 of the excavator 1.

In the present embodiment, the central evaluation unit 24 is configured to generate at least two sub-calculation commands T, each of which is designed to determine an intermediate value Z of the central evaluation algorithm, and to provide each of the sub-calculation commands T to the computing unit 20 of one of the sensor devices 12_1-12_5.

In the example shown in FIG. 3, five sub-calculation commands T_1-T_5 are generated by the central evaluation unit 24, wherein the first sub-calculation command T_1 is executed by the computing unit 20 of the first sensor device 12_1, which forms the central evaluation unit 24, itself, the second sub-calculation command T_2 is provided by the central evaluation unit 24 via the data transmission network 14 to the computing unit 20 of the second sensor device 12_2 and is executed by the latter, the third sub-calculation command T_3 is provided by the central evaluation unit 24 via the data transmission network 14 to the computing unit 20 of the third sensor device 12_3 and is executed by the latter, the fourth sub-calculation command T_4 is provided by the central evaluation unit 24 via the data transmission network 14 to the computing unit 20 of the fourth sensor device 12_4 and is executed by the latter, and the fifth sub-calculation command T_5 is provided by the central evaluation unit 24 via the data transmission network 14 to the computing unit 20 of the fifth sensor device 12_5 and is executed by the latter.

Furthermore, in the present embodiment, the central evaluation unit 24 is configured to retrieve the intermediate values Z calculated by the sub-calculation commands T in the computing units 20 of the respective sensor device 12 from the respective sensor devices 12.

In the example shown in FIG. 3, the second intermediate value Z_2 calculated by the second sub-calculation command T_2 in the computing unit 20 of the second sensor device 12_2, the third intermediate value Z_3 calculated by the third sub-calculation command T_3 in the computing unit 20 of the third sensor device 12_3, the fourth intermediate value Z_4 calculated by the fourth sub-calculation command T_4 in the computing unit 20 of the fourth sensor device 12_4 and the fifth intermediate value Z_5 calculated by the fifth sub-calculation command T_5 in the computing unit 20 of the fifth sensor device 12_5 are retrieved by the central evaluation unit from the respective sensor device 12 via the data transmission network 14. The central evaluation unit 24 also has access to the first intermediate value Z_1 calculated in the computing unit 20 of the first sensor device 12_1.

All calculated intermediate values Z_1-Z_5 are provided to the central evaluation algorithm, which based thereon determines the five individual output data A_1-A_5 for the five sensor devices 12_1-12_5.

The central evaluation unit 24 is further configured to provide the determined output data A_1-A_5 to the respective sensor device 12. In particular, the central evaluation unit 24 is configured to transmit the determined second output data A_2 to the second sensor devices 12_2 via the data transmission network 14, to transmit the determined third output data A_3 to the third sensor devices 12_3 via the data transmission network 14, to transmit the determined fourth output data A_4 to the fourth sensor devices 12_4 via the data transmission network 14, and to transmit the determined fifth output data A_5 to the fifth sensor devices 12_5 via the data transmission network 14. The determined first output data A_1 is stored in the first sensor device 12_1, the computing unit 20 of which constitutes the central evaluation unit 24.

The output data A_1-A_5 can then be read out via the data interface 22 of the respective sensor device 12. In particular, the first output data A_1 can be read out via the data interface 22 of the first sensor devices 12_1, the second output data A_2 can be read out via the data interface 22 of the second sensor devices 12_2, the third output data A_3 can be read out via the data interface 22 of the third sensor devices 12_3, the fourth output data A_4 can be read out via the data interface 22 of the fourth sensor devices 12_4 and the fifth output data A_5 can be read out via the data interface 22 of the fifth sensor devices 12_5.

### LIST OF REFERENCE NUMERALS

1 excavator
2 undercarriage
3 upper carriage
4 boom
5 stick
6 bucket
10 sensor network system
12 sensor devices
14 data transmission network
16 first detection unit (gyroscope sensor unit)
18 second detection unit (acceleration sensor unit)
20 computing unit
22 data interface
24 central evaluation unit
A output data
M measurement data
T sub-calculation commands
Z intermediate values

1. Sensor network system (10) with a plurality of sensor devices (12_1 12_5), each comprising:
a detection unit (16, 18) for detecting a physical quantity and for providing a corresponding measurement signal,
a computing unit (20) for processing the measurement signal and for providing measurement data (M_1-M_5) which is based on the measurement signal, and
a data interface (22) via which output data (A_1-A_5) can be read out,
characterized in that
a central evaluation unit (24) is provided, which is configured to:
determine individual output data (A_1-A_5) for the at least two sensor devices (12_1-12_5) based on the measurement data (M_1-M_5) of at least two of the sensor devices (12) via a central evaluation algorithm, and
provide the determined output data (A_1-A_5) to the respective sensor device (12_1-12_5).

2. Sensor network system (10) according to claim 1, wherein the central evaluation unit (24) is constituted by the computing unit (20) of one of the sensor devices (12_1-12_5).

3. Sensor network system (10) according to one of the preceding claims, wherein the central evaluation unit (24) is further configured to:
generate at least two sub-calculation commands (T_1-T_5) for calculating an intermediate value (Z_1-Z_5) of the central evaluation algorithm,
provide the at least two sub-calculation commands (T_1-T_5) to the computing units (20) of at least two different sensor devices (12_1-12_5), and
receive or retrieve the intermediate values (Z_1-Z_5) which are calculated in the computing units (20) of the at least two different sensor devices (12_1-12_5) by the at least two sub-calculation commands (T_1-T_5) from the at least two different sensor devices (12_1-12_5).

4. Sensor network system (10) according to one of the preceding claims, wherein:
the sensor devices (12_1-12_5) each comprise a gyroscope sensor unit (16) and/or an acceleration sensor unit (18),
the sensor devices (12_1-12_5) are each attached to a different movable part (2,3,4,5,6) of a machine (1), and
the output data (A_1-A_5) of the sensor devices (12_1-12_5) each indicate a spatial position and/or orientation of the respective part (2,3,4,5,6) of the machine (1).
